(19) United States
(12) Patent Application Publication
(10) Pub. No.: US 2016/0125756 A1
(43) Pub. Date: May 5, 2016

(54) Method for motivating students to receive high grades

(71) Applicant: Christopher Johnson, Piscataway, NJ (US)

(72) Inventor: Christopher Johnson, Piscataway, NJ (US)

(21) Appl. No.: 14/828,532

(22) Filed: Aug. 18, 2015

Related U.S. Application Data
(60) Provisional application No. 62/073,139, filed on Oct. 31, 2014.

(51) Int. Cl. G09B 19/00; G09B 5/00

(52) U.S. Cl. CPC G09B 19/00; G09B 5/00

(57) ABSTRACT

A method motivating students to receive high grades by providing the students with points which can be used by them to obtain products offered by businesses. The method allow teachers to verify the grades of the students. The method allow students, parents, teachers and businesses to communicate with each other.

### CROSS-REFERENCE TO RELATED APPLICATIONS

This application claims benefit of provisional application 62/073,139 filed on Oct. 31, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of computer-implemented methods for motivating students to receive high grades. More particularly, the present invention is in the technical field of computer-implemented methods for motivating students to receive high grades by providing the students with rewards.

Relevant prior art includes:

U.S. Pat. No. 4,715,011 December, 1987 Brittan.

U.S. Pat. No. 4,820,167 April, 1989 Nobles, et al.

U.S. Pat. No. 5,864,869 January, 1999 Doak, et al.

U.S. Pat. No. 7,483,522 January, 2009 Cohen, et al.

U.S. Pat. No. 8,113,848 February, 2012 Gelbart, et al.

U.S. Pat. No. 8,180,274 May, 2012 Bender.

U.S. Pat. No. 8,418,223 April, 2013 Smith, et al.

U.S. Pat. No. 8,775,515 July, 2014 Lippert, et al.

There is existing prior art related to the use of electronic computing devices in the field of education. For example, U.S. Pat. No. 4,715,011 discloses a calculator for use by teachers for rapidly and easily converting numeric scores into letter grades. U.S. Pat. No. 4,820,167 discloses an electronic school teaching system which includes a data collection computer, teacher's computers and a student's electronic and test units. U.S. Pat. No. 5,864,869 discloses a method and manufacture of lesson plans and classroom organizers utilizing computers and software.

There is existing prior art related to motivating students to receive high grades. For instance, U.S. Pat. No. 8,113,848 discloses a method for motivating students to improve their grade point average using a network system which generates wagering odds for the student to achieve first grades for current class schedule.

However, the existing prior art does not disclose a method of motivating students to receive high grades by providing the students with products in case they receive high grades. Such an invention can motivate the students to receive high grades and contribute to the well-being of the society.

### SUMMARY OF THE INVENTION

The present invention is a computer-implemented method for motivating students to receive high grades by providing the students with points if they obtain certain grades. The points can be used by the students to receive goods and/or services. In addition, the present invention allows teachers to verify the grades of the students. Moreover, the present invention allows students, parents, teachers and businesses to communicate with each other.

### BRIEF DESCRIPTION OF THE DRAWINGS

FIG. 1 displays a user interface allowing parents and students to register an account;

FIG. 2 displays a user interface allowing businesses to register an account;

FIG. 3 displays a user interface allowing teachers to register an account;

FIG. 4 displays a user interface allowing students to upload their grades;

FIG. 5 displays a user interface allowing businesses to add products which students can receive in exchange for their points;

FIG. 6 displays a user interface allowing users to view the profile of a student and send a note to that student;

FIG. 7 displays a user interface allowing users to see the notes received by them;

FIG. 8 displays a user interface allowing users to find and add students;

FIG. 9 displays a user interface allowing users to see and verify the grades of students;

FIG. 10 displays a user interface allowing users to see the points that the students will obtain if the students receive certain grades;

FIG. 11 is a flow chart illustrating an exemplary process of operation of one embodiment of the invention.

### DRAWINGS—REFERENCE NUMERALS

8—field allowing users to choose the type of account they would like to register;

10—button allowing users to choose the type of the account they would like to register;

12—field requesting the personal information of a parent;

14—field requesting the personal information of a student;

16—button allowing the user to select and add the grade level of the student;

18—field requesting the business to provide certain business information;

20—field requesting the business to provide information about its login credentials;

22—field requesting the teacher to provide certain personal information;

24—field requesting the teacher to provide information about his/her login credentials;

26—field “Grade Earned”;

27—field “Upload Type”;

28—button allowing the student to upload a file containing the grade;

29—field requesting the student to select the class to which the grade relates;

30—button allowing the student to select the class to which a grade relates;

31—field requesting the student to provide information on the examination on which the grade is based;

32—fillable field “What is this grade for”;

34—field requesting the student to state whether the grade relate to a test or to a report card;

35—field requesting the student to enter the date of the grade;

36—fillable field “Date” allowing the student to enter the date to which the grade relates;

38—field containing information about the name of the student;

40—field displaying the name of selected product;

42—field allowing the student to choose a product;

43—button allowing the student to choose a product;

44—field displaying an image of the selected product;

46—field containing a description of the selected product;

48—button allowing the user to add a product;

50—field indicating the number of the points that the user need to use in order to receive the selected product;

52—field containing the personal data of a student;

53—field allowing the user to see notes sent to a student and send new notes to a student;

54—field containing the name of a note that was sent to a student;

55—field containing information about the name of a note, the date of a note, and the content of a note sent to student;

56—fillable field allowing the user to enter the name of a new note that will be sent to a student;

58—field showing the date when a note was sent to a student;

60—field showing the content of a note that was sent to a student;

62—fillable field allowing the user to type a new note to a student;

64—button “submit” allowing the user to send a note a student;

66—field containing the name of a note that was received by the user;

68—field “Count of unread messages”;

69—field containing information about one or more notes sent to the user;

70—field indicating the author of a received note;

72—field indicating the date of a received note;

74—field showing the name of a received note;

76—field allowing the user to send a new note;

77—field containing information about a student;

78—field indicating the username of a student;

80—field indicating the first name of a student

82—field indicating the last name of a student;

84—field indicating the school of a student;

86—field indicating the grade level of a student;

88—button allowing the user to find a student and add a student to a list of students;

90—field indicating the subject in which a grade of a selected student was received;

92—field allowing the user to select a student whose grades will be viewed;

93—button “select” allowing the user to select a student whose grades will be viewed;

94—field showing the name of the selected student;

96—field showing grades of the selected student;

98—field showing the class in which the selected student obtained the grade;

100—field indicating whether the grade was stated in a test or in a report card;

101—field containing information about a grade obtained by a student;

102—field indicating the date of the received grade;

104—field indicating whether a teacher verified the grade;

106—field indicating whether the parent of a student verified the grade;

108—button allowing the user to edit the grade of the student;

109—field indicating the grades and points received in relation to tests and quizzes;

110—field indicating grades received in relation to tests and quizzes;

111—field indicating grades and points obtained in relation to report cards;

112—field indicating the points that a student will receive in relation to the grades concerning tests and quizzes;

114—field indicating grades received in relation to report cards;

116—field indicating points concerning report cards;

118—start of an exemplary process of operation of the invention;

120—students, parents, teachers, and businesses register accounts;

122—students upload their grades;

124—teachers verify the grades uploaded by students;

126—students receive points for their grades;

128—businesses can upload product offers;

130—students can use the points to receive products offered by businesses;

132—end of an exemplary process of operation of one embodiment of the invention.

### DETAILED DESCRIPTION OF THE INVENTION

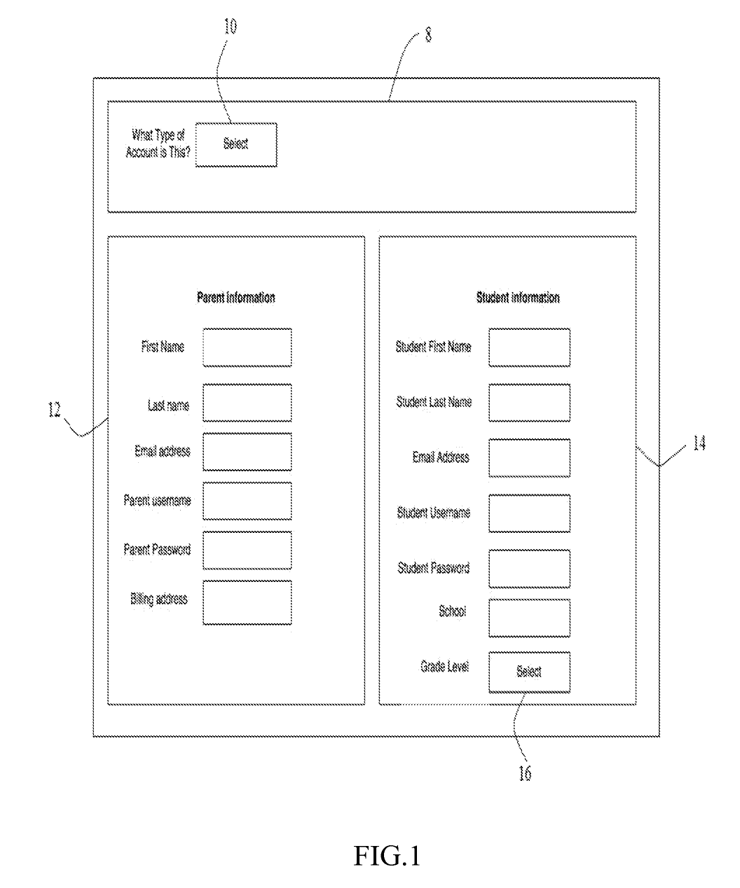

Referring now to the invention in more detail, in FIG. 1, there is shown a user interface allowing parents and students to register an account. The user interface in FIG. 1 contains a field allowing users to choose the type of account they would like to register 8 which includes a button allowing users to choose the type of the account they would like to register 10. In particular, the users can choose to register a business account, a parent account, a student account, or a teacher account. If a student or a parent would like to register a student account or a parent account, the student or the parent will need to fill in two fields of the interface shown on FIG. 1, namely, the field requesting the personal information of a parent 12 and the field requesting the personal information of a student 14. The field requesting the personal information of a parent 12 contains six fillable fields, namely, “First Name”, “Last Name”, “Email Address”, “Parent Username”, “Parent Password”, and “Billing Address”. The field requesting the personal information of a student 14 contains six fillable fields, namely, “Student First Name”, “Student Last Name”, “Email Address”, “Student Username”, “Student Password”, “School”, and a button allowing the user to select the grade level of the student 16.

In more detail, still referring to the invention of FIG. 1, when the user clicks on the button allowing users to choose the type of the account they would like to register 10 and the user chooses to register a student or a parent account, the invention will display a field requesting the personal information of a parent 12 and a field requesting the personal information of a student 14. The personal data collected through the field requesting the personal information of a parent 12 and the field requesting the personal information of a student 14 will be used by the invention for the creation of accounts of a parent and a student. The accounts of a parent and a student will consist of profiles displaying their personal data. In one embodiment of the invention, the field requesting the personal information of a student 14 asks the students to provide their location information.

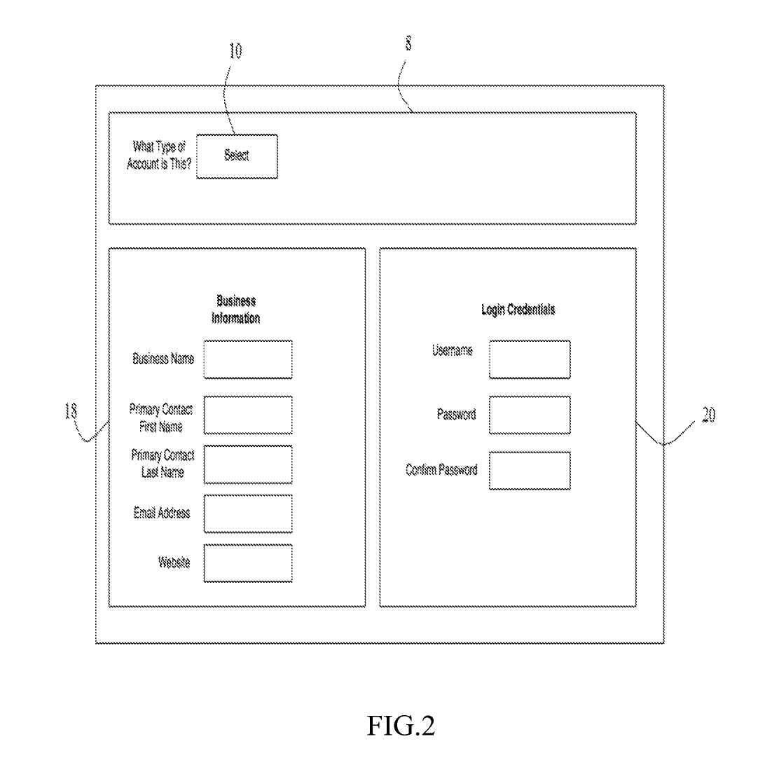

Referring now to the invention in more detail, in FIG. 2, there is shown a user interface allowing businesses to register business accounts. The user interface in FIG. 2 contains a field allowing users to choose the type of account they would like to register 8 which includes a button allowing users to choose the type of the account they would like to register 10. In particular, the users can choose to register a business account, a parent account, a student account, or a teacher account. If a business would like to register a business account, it will need to fill in the fields in two fields of the interface shown on FIG. 2, namely, a field requesting the business to provide certain business information 18 and a field a requesting the business to provide information about its login credentials 20. The field requesting the business to provide certain business information 18 contains five fillable fields, namely, “Business Name”, “Primary Contact First Name”, “Primary Contact Last Name”, “Email Address”, and a “Website”. The field requesting the business to provide information about its login credentials 20 contains three fillable fields, namely, “User Name”, “Password”, and “Confirm Password”.

In more detail, still referring to the invention of FIG. 2, when the user clicks on the button allowing users to choose the type of the account they would like to register 10 and chooses to register a business account, the invention will display a field requesting the business to provide certain business information 18 and a field requesting the business to provide information about its login credentials 20. The personal data collected through the field requesting the business to provide certain business information 18 and the field requesting the business to provide information about its login credentials 20 will be used by the invention for the creation of a business account. The account of a business will consist of a profile displaying information about the business which registered the account.

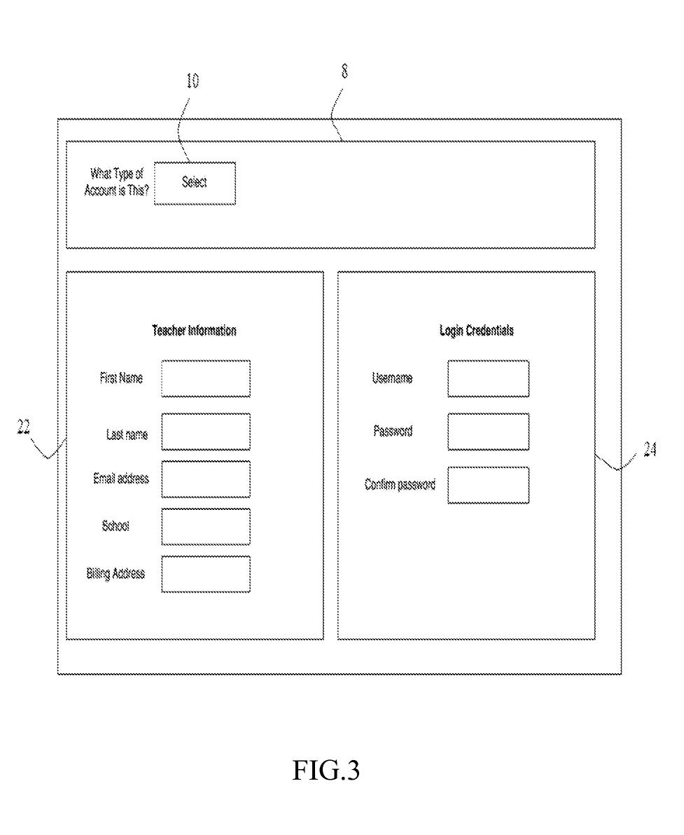

Referring now to the invention in more detail, in FIG. 3, there is shown a user interface allowing teachers to register an account. The user interface in FIG. 3 contains a field allowing users to choose the type of account they would like to register 8 which includes a button allowing users to choose the type of the account they would like to register 10. In particular, the users can choose to register a business account, a parent account, a student account, or a teacher account. If a teacher would like to register a teacher account, he/she will need to fill in two fields of the interface shown on FIG. 3, namely, the field requesting the teacher to provide certain personal information 22 and the field requesting the teacher to provide information about his/her login credentials 24. The field requesting the teacher to provide certain personal information 22 contains the following fields: “First Name”, “Last Name”, “Email address”, “School”, and “Billing Address”. The field requesting the teacher to provide information about his/her login credentials 24 contains three fillable fields, namely, “User Name”, “Password”, and “Confirm Password”.

In more detail, still referring to the invention of FIG. 3, when the user clicks on the button allowing users to choose the type of the account they would like to register 10 and chooses to register a teacher account, the invention will display a field requesting the teacher to provide certain personal information 22 and a field requesting the teacher to provide information about his/her login credentials 24. The personal data collected through the field requesting the teacher to provide certain personal information 22 and the field requesting the teacher to provide information about his/her login credentials 24 will be used by the invention for the creation of a teacher account. The account of a teacher will consist of a profile displaying information about the teacher who registered the account.

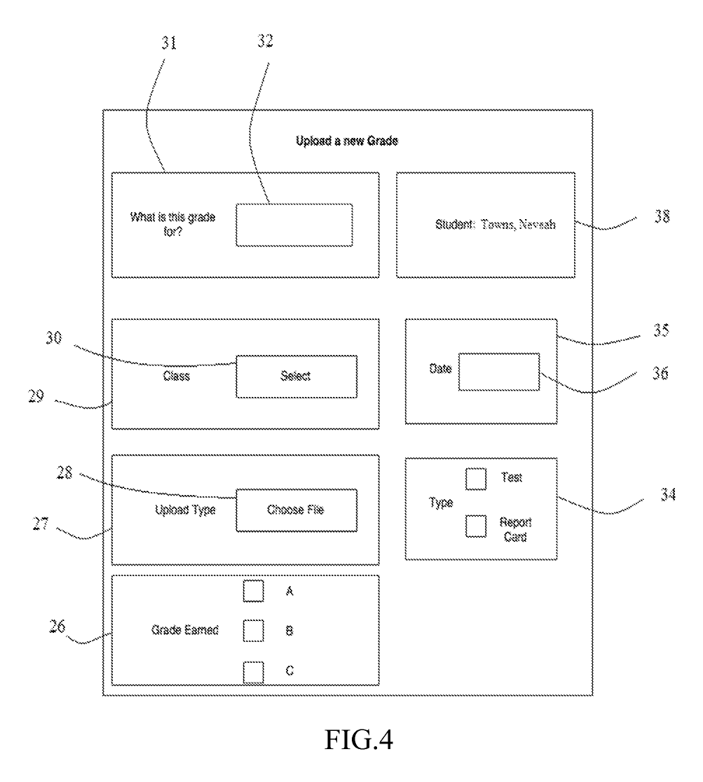

Referring now to the invention in more detail, in FIG. 4, there is shown a user interface allowing students to upload their grades. The user interface displayed on FIG. 4 consists of field “Grade Earned” 26, field “Upload Type” 27, button allowing the student to upload a file containing the grade 28, field requesting the student to select the class to which the grade relates 29, button allowing the student to select the class to which a grade relates 30, field requesting the student to provide information on the examination on which the grade is based 31, fillable field “What is this grade for” 32, field requesting the student to state whether the grades relates to a test or to a report card 34, field requesting the student to enter the date of the grade 35, fillable field “Date” allowing the student to enter the date to which the grade relates 36, and field containing information about the name of the student 38.

In more detail, still referring to the invention of FIG. 4, the field “Grade Earned” 26 allows the users to choose amongst one of three grades, namely, “A”, “B”, and “C”. The field “Upload Type” 27 contains a button allowing the student to upload a file containing the grade 28. The field requesting the student to select the class to which the grade relates 29 contains a button allowing the student to select the class to which a grade relates 30. The field requesting the student to provide information on the examination on which the grade is based 31 contains a fillable field “What is this grade for” 32. The field requesting the student to state whether the grades relates to a test or to a report card 34 allows the user to choose between two options, namely, “Test” and “Report Card”. These two options refer to whether the grade is stated in a test or in a report card. The field requesting the student to enter the date of the grade 35 contains a fillable field “Date” allowing the student to enter the date to which the grade relates 36. The field containing information about the name of the student 38 indicates the first name and the family name of a student.

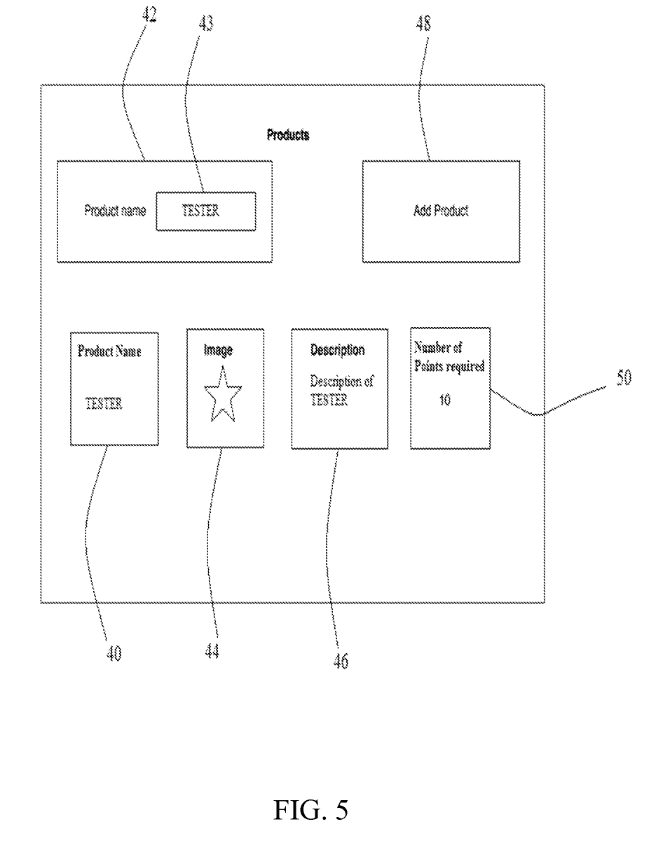

Referring now to the invention in more detail, in FIG. 5, there is shown a user interface allowing businesses to add products which students can receive in exchange for their points. These products can be either goods or services. The user interface displayed on FIG. 5 consists of a field displaying the name of selected product 40, a field allowing the user to choose a product 42, a button allowing the student to choose a product 43, a field displaying an image of the selected product 44, a field containing description of the selected product 46, a button allowing the user to add a product 48, and a field indicating the number of the points that the user need to use in order to receive the selected product 50.

In more detail, still referring to the invention of FIG. 5, by clicking on a button allowing the student to choose a product 43 located in the field allowing the student to choose a product 42, a student will be able to choose a product which he or she would like to receive in exchange for points. The field displaying the name of selected product 40, the field displaying an image of the selected product 44, the field containing a description of the selected product 46, and the field indicating the number of the points that the user need to use in order to receive the selected product 50 allow the user to receive detailed information about the selected product. The field allowing the user to add a product 48 will allow business users to add products which students can receive in exchange for points.

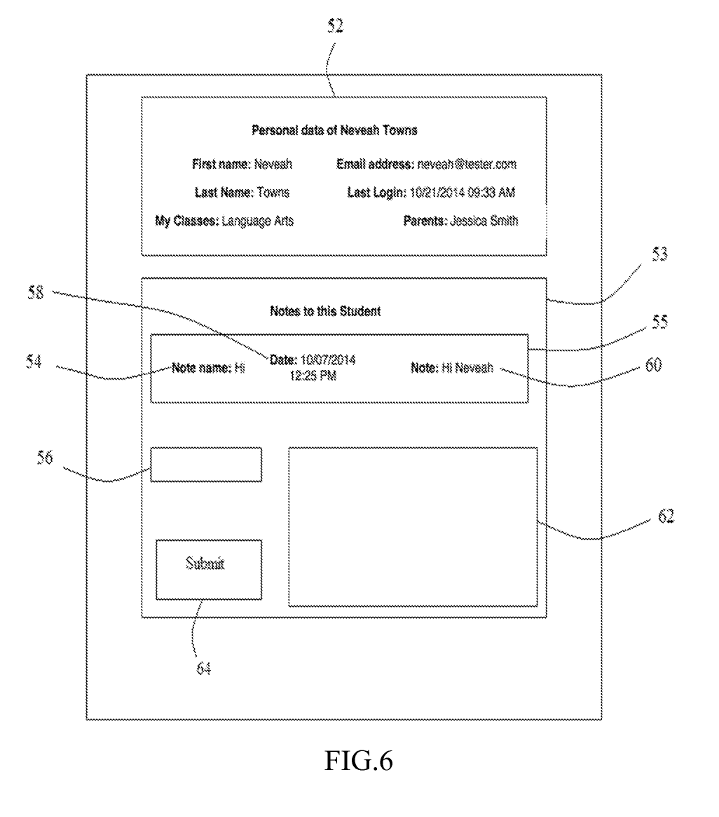

Referring now to the invention in more detail, in FIG. 6, there is shown a user interface allowing users to view the profile of a student and send a note to that student. The user interface displayed on FIG. 6 consists of field containing the personal data of a student 52, field allowing the user to see notes sent to a student and send new notes to a student 53, field containing the name of a note that was sent to a student 54, field containing information about the name of a note, the date of a note, and the content of the note 55, fillable field allowing the user to enter the name of a new note that will be sent to a student 56, field showing the date when a note was sent to a student 58, field showing the content of a note that was sent to a student 60, fillable field allowing the user to type a new note to a student 62, and a button “submit” allowing the user to send a note a student 64.

In more detail, still referring to the invention of FIG. 6, the field containing the personal data of a student 52 provides the users of the invention with information about the first name of a student, the last name of a student, the classes in which a student participates, the email address of a student, the last login of the student in the software application implementing the invention, and the name of one or more parents of the student. The field allowing the user to see notes sent to a student and send new notes to a student 53 contains a field containing information about the name of a note, the date of a note, and the content of a note sent to student 55, a fillable field allowing the user to enter the name of a new note that will be sent to a student 56, button “submit” allowing the user to send a note a student 64, and fillable field allowing the user to type a new note to a student. The field containing information about the name of a note, the date of a note, and the content of a note sent to student 55 contains a field showing the name of a note that was sent to a student 54, a field showing the date when a note was sent to a student 58, a field showing the content of a note that was sent to a student 60.

The user interface displayed in FIG. 6 can be used by the users of the invention for communicating with one or more students. Thus, the invention not only provides the students with an opportunity to receive points in relation to their grades, but also allows communication between the users that may motivate the students to receive high grades.

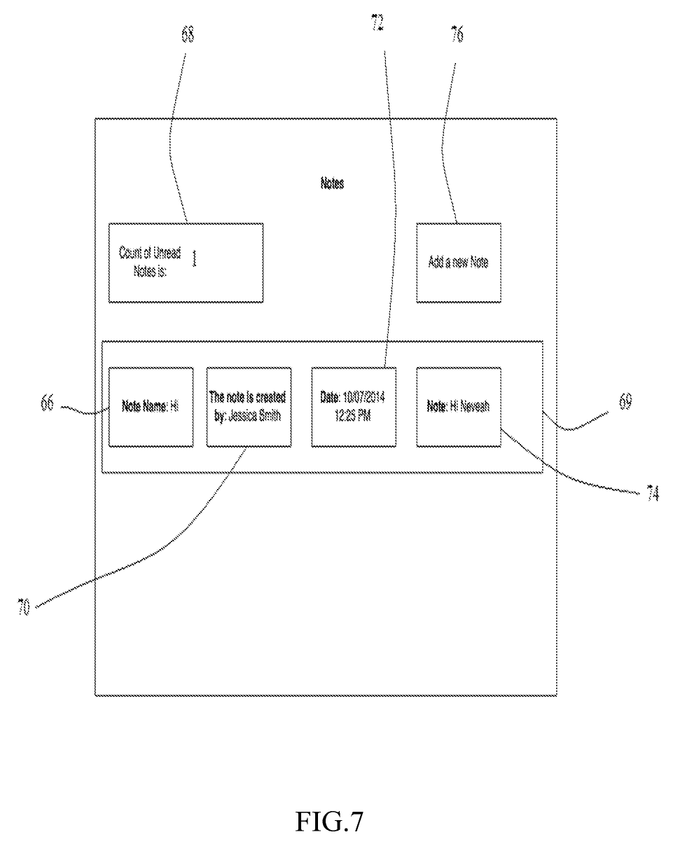

Referring now to the invention in more detail, in FIG. 7, there is shown a user interface allowing users to see the notes received by them. The user interface displayed on FIG. 7 consists of six fields, namely, a field containing the name of a note that was received by the user 66, a field “Count of unread messages” 68, a field containing information about one or more notes sent to the user 69, a field indicating the author of a received note 70, a field indicating the date of a received note 72, a field showing the name of a received note 74, and a field allowing the user to send a new note 76.

In more detail, still referring to the invention of FIG. 7, the field containing information about one or more notes sent to the user 69 contains a field containing the name of a note that was received by the user 66, the field indicating the author of a received note 70, a field indicating the date of a received note 72 and the field showing the name of a received note 74. The field “Count of unread messages” 68 allows the user to see the number of the unread messages. The field allowing the user to send a new note 76 can be used by the user in order to send a new note to another user.

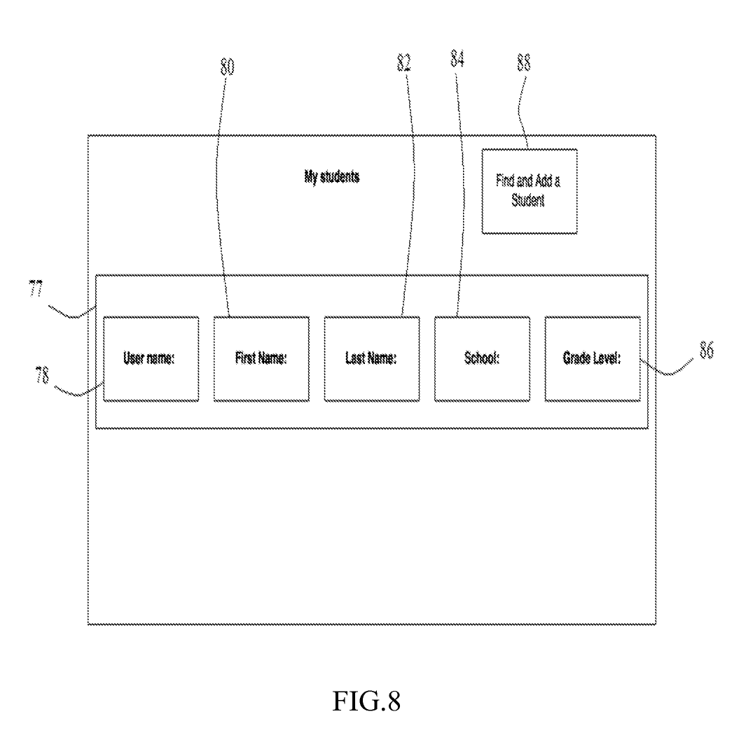

Referring now to the invention in more detail, in FIG. 8, there is shown a user interface allowing users of the invention to find and add students. The user interface displayed on FIG. 8 consists of a field containing information about a student 77 and a button allowing the user to find a student and add a student to a list of students 88. The field containing information about the student 77 includes a field indicating the username of a student 78, a field indicating the first name of a student 80, a field indicating the last name of a student 82, a field indicating the school of a student 84, and a field indicating the grade level of a student 86.

In more detail, still referring to the invention of FIG. 8, the field containing information about a student 77, the field indicating the username of a student 78, the field indicating the first name of a student 80, the field indicating the last name of a student 82, the field indicating the school of a student 84, and the field indicating the grade level of a student 86 provide the user with information about the names, school, and the grade level of a student. The button allowing the user to find a student and add a student to a list of students 88 provides the users with opportunity to create a list of students with whom the users can communicate.

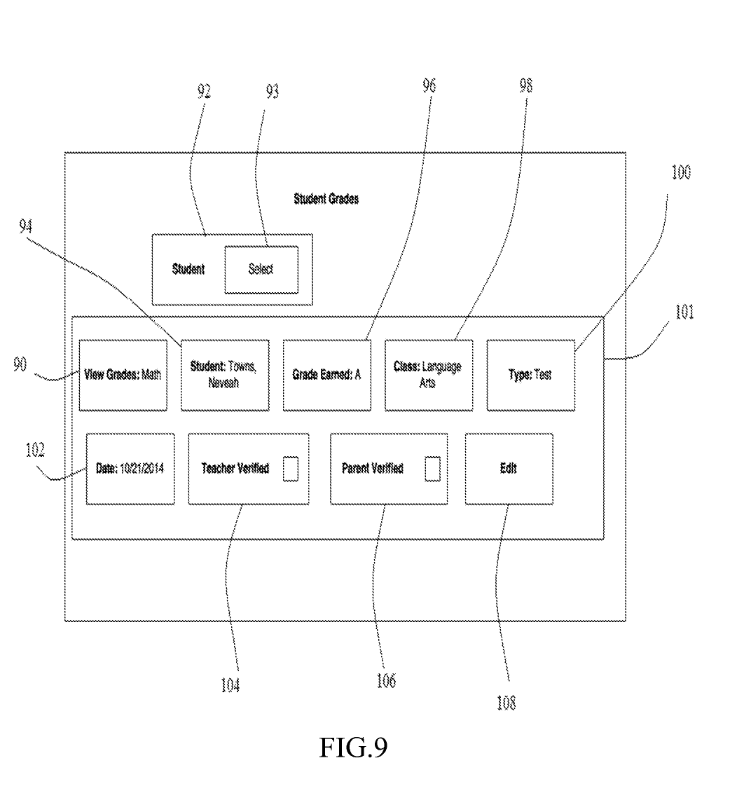

Referring now to the invention in more detail, in FIG. 9, there is shown a user interface allowing users to see and verify the grades of students. The user interface shown on FIG. 9 consists of a field indicating the subject in which a grade of a selected student was received 90, a field allowing the user to select a student whose grades will be viewed 92, a button “select” allowing the user to select a student whose grades will be viewed 93, a field showing the name of the selected student 94, a field showing grades of the selected student 96, a field showing the class in which the selected student obtained the grade 98, a field indicating whether the grade was stated in a test or in a report card 100, a field containing information about a grade obtained by a student 101, a field indicating the date of the received grade 102, a field indicating whether a teacher verified the grade 104, a field indicating whether the parent of a student verified the grade 106, and a field allowing the user to edit the grade of the student 108.

In more detail, still referring to the invention of FIG. 9, the field containing information about a grade obtained by a student 101 consists of a field indicating the subject in which a grade of a selected student was received 90, a field showing the name of the selected student 94, field showing grades of the selected student 96, a field showing the class in which the selected student obtained the grade 98, a field indicating whether the grade was stated in a test or in a report card 100, a field indicating the date of the received grade 102, a field indicating whether a teacher verified the grade 104, a field indicating whether the parent of a student was verified 106, a button allowing the user to edit the grade of the student 108. The field allowing the user to select a student whose grades will be viewed 92 includes a button “select” allowing the user to select a student whose grades will be viewed 93. After clicking on the button “select” allowing the user to select a student whose grades will be viewed 93, the user will have the opportunity to choose one out of possibly large number of students whose grades will be closely examined. The button allowing the user to edit the grade of the student 108 provides the user with opportunity to edit the grades of the selected student.

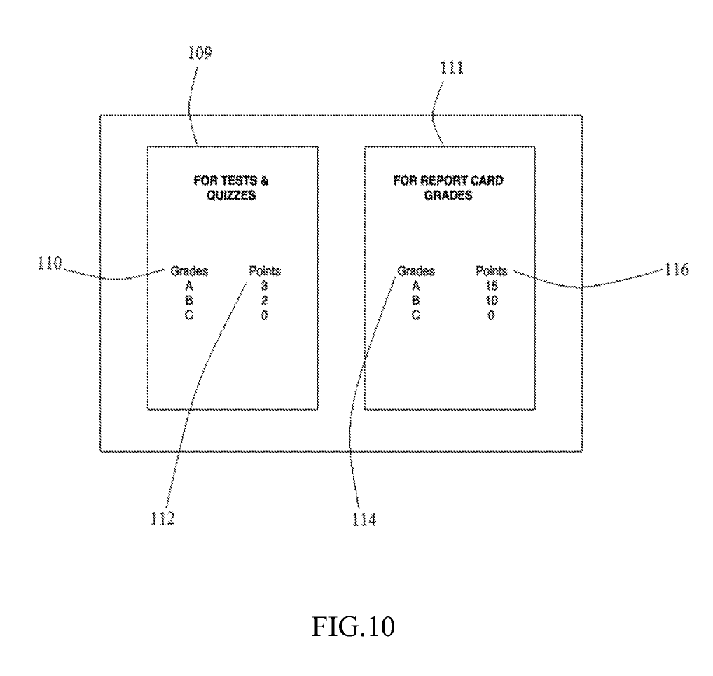

Referring now to the invention in more detail, in FIG. 10, there is shown a user interface allowing users to see the points that the students can obtain if the students receive certain grades. The user interface shown on FIG. 10 consists of a field indicating the grades and points received in relation to tests and quizzes 109, a field indicating grades received in relation to tests and quizzes 110, a field indicating grades and points obtained in relation to report cards 111, a field indicating the points that a student will receive in relation to the grades concerning tests and quizzes 112, a field indicating grades received in relation to report cards 114, a field indicating points concerning report cards 116.

In more detail, still referring to the invention of FIG. 10, the grades in the field indicating the grades received in relation to tests and quizzes 110 will allow students to receive points as specified in the field indicating the points that a student will receive in relation to the grades concerning tests and quizzes 112. The grades in the field indicating the grades received in relation to report cards 114 will allow the students to receive points specified in the field indicating points concerning report cards 116.

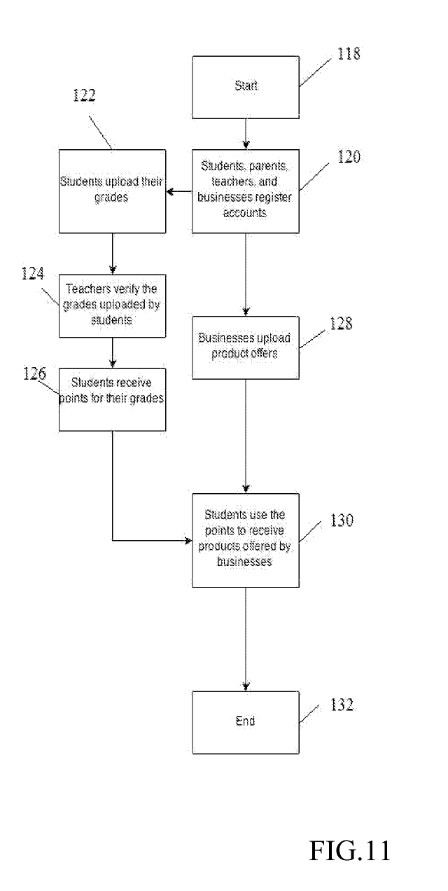

Referring now to the invention in more detail, in FIG. 11, there is shown a flow chart illustrating an exemplary process of operation of one embodiment of the invention. After the start of the exemplary process of operation of the invention 118, students, parents, teachers, and businesses register accounts 120 Immediately after students, parents, teachers, and businesses register accounts 120, students can upload their grades 122 and businesses can upload product offers 128. After students upload their grades 122, teachers verify the grades uploaded by students 124. After the teachers verify the grades uploaded by students 124, students receive points for their grades 126. Then, students can use the points to receive products offered by businesses 130. After the students receive products offered by businesses 130, the exemplary process of operation of one embodiment of the invention ends 132.

In one embodiment of the invention, the invention may operate without the need for students, parents, teachers, and businesses register accounts 120. In one embodiment, students can capture a photo of their grades by using the camera of their own mobile devices and, afterwards, students can upload their grades 122. In one embodiment of the invention, businesses can upload product offers 128 that can be received by students within a certain geographic area only. In one embodiment, students can use the points to receive products offered by businesses 130 only if such businesses are located within a geographic area selected by the students. In one embodiment, students upload their grades 122 and documents indicating their positive behavior and social accomplishments. In one embodiments, students receive points for their grades 126 and for their positive behavior and social accomplishments. In one embodiment, if teachers verify the grades uploaded by students 124, teachers will receive points for verifying grades of students. In one embodiment, teachers verify the grades uploaded by students 124 by clicking on a link sent by the invention to the email address of the teachers. In one embodiment, students can use the points to receive products offered by businesses 130 as well as services at a discounted price offered by businesses. In one embodiment, students can use the points to receive products offered by businesses 130 as well as free access to events organized by businesses. In one embodiment of the invention students receive points for their grades 126 as well as points provided by the invention to randomly selected users having high grades. In one embodiment of the invention students receive points for their grades 126 as well as points provided by the invention to randomly selected users who successfully pass a test. In one embodiment, students can use the points to receive products offered by businesses 130 as well as for providing products and services offered by businesses to people in disadvantaged world regions. In one embodiment, students can use the points to receive products offered by businesses 130 as well as for funding projects created by people in disadvantaged world regions.

One advantage of the invention is that it motivates students throughout their academic careers to achieve high grades. Another advantage of the invention is that it allows students, parents, teachers and business to communicate with each other. Another advantage of the invention is that it allows businesses to advertise their products to students, parents, teachers and other businesses.

In broad embodiment, the present invention is a method for motivating students to receive high grades. The method allows students to upload their grades. Teachers verify the grades uploaded by students. The method provides the students with points depending on the grades obtained by the students. Students can use the received point to obtain products provided by businesses.

The embodiment is able to be implemented, for example, using a machine-readable medium or article which is able to store an instruction or a set of instructions that, if executed by a machine, cause the machine to perform the operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software.

The machine-readable medium or article is able to include, for example, any suitable type of memory unit, memory device, memory article, memory medium, storage device, storage article, storage medium and/or storage unit; for example, memory, removable or non-removable media, erasable or non-erasable media, write-able or re-write-able media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like.

The instructions are able to include any suitable type of code, for example, source code, compiled code, interpreted code, executable code, static code, dynamic code, or the like, and are able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A computer-implemented method for motivating students to receive high grades comprising:
providing students, parents, teachers, and businesses with forms that can be used for registration of accounts;
providing students with a form allowing them to upload the grades they receive in school;
providing teachers with a form allowing them to verify the grades of the students;
providing students with points received for their grades; and
providing students who receive the said points with an opportunity to exchange their points for products provided by businesses.

2. The method according to claim 1, wherein the students have the option to capture their grades with a camera.

3. The method according to claim 1, wherein the students who receive the said points have the opportunity to exchange their points for products provided by businesses located within the geographic area of the students.

4. The method according to claim 1, wherein the students receive points for their positive behavior and social accomplishments.

5. The method according to claim 1, wherein teachers receive points for verifying the grades of students.

6. The method according to claim 1, wherein teachers verify the grades of students by clicking on a web link sent to the email address of the teachers.

7. The method according to claim 1, wherein students receive product and services at a discounted price in exchange for their points.

8. The method according to claim 1, wherein students receive free access to events in exchange for their points.

9. The method according to claim 1, wherein students receive points provided to randomly selected students having high grades.

10. The method according to claim 1, wherein students receive points provided to randomly selected users who successfully pass a test.

11. The method according to claim 1, wherein students can use their points to provide products and services offered by businesses to people in disadvantaged world regions.

12. The method according to claim 1, wherein students can use their points to fund projects created by people in disadvantaged world regions.

13. The method according to claim 1, wherein students, parents, teachers and businesses can communicate with each other.

14. A computer-implemented method for motivating students to receive high grades comprising:
providing students with a form allowing them to upload the grades they receive in school;
providing teachers with a form allowing them to verify the grades of the students;
providing students with points received for their grades; and
providing students who receive the said points with an opportunity to exchange their points for products provided by businesses.
